(19) United States
(12) Patent Application Publication
(10) Pub. No.: US 2024/0051688 A1
(43) Pub. Date: Feb. 15, 2024

(54) VERTICAL TAKEOFF AND LANDING HYBRID DRONE SUITABLE FOR FLYING IN WINDY CONDITIONS

(71) Applicant: TIDAV, BLAGNAC (FR)

(72) Inventors: Philippe VALERO, Toulouse (FR); Vivien JOURDON, Toulouse (FR); Cédric LEFORT, Blagnac (FR)

(73) Assignee: TIDAV, BLAGNAC (FR)

(21) Appl. No.: 18/280,173

(22) PCT Filed: Mar. 1, 2022
(86) PCT No.: PCT/EP2022/055064

§ 371 Date: Sep. 1, 2023

(30) Foreign Application Priority Data
Mar. 1, 2021 (FR) FR2101971

(51) Int. Cl. B64U 10/20; B64C 29/00; B64C 11/30; B64C 5/06; B64U 30/20; B64C 11/32

(52) U.S. Cl. CPC B64U 10/20; B64C 29/0033; B64C 11/306; B64C 5/06; B64U 30/20; B64C 11/32; B64U 2101/00

(57) ABSTRACT

The invention relates to a hybrid vertical take-off and landing drone comprising at least two substantially parallel fixed wings (12, 14) each comprising at least two fins (16a, 16b, 18a, 18b) distributed on either side of a roll axis (200) of the drone and individually controlled, characterized in that it comprises at least two counter-rotating rotors (20a, 20b) with a collective pitch system (24a, 24b) and a swashplate (26a, 26b), which are arranged between two wings on either side of the roll axis (200a), individually controlled and articulated so as to allow independent tilting of each rotor on a tilt axis (22a, 22b) substantially parallel to the pitch axis of the drone, the rotational axis of the blades of each rotor being substantially perpendicular to said tilt axis.

### TECHNICAL FIELD OF THE INVENTION

The invention relates to a hybrid vertical take-off and landing drone adapted for flight in windy conditions. In particular, the invention relates to a drone capable of hovering flight in the manner of a helicopter and high-speed flight owing to a fixed wing in the manner of an airplane, having control means for reducing the influence of wind on the flight, in particular during hovering flight.

### TECHNOLOGICAL BACKGROUND

Drones, also referred to as Unmanned Aerial Vehicles, or UAVs, are aircraft having different features depending upon the applications for which they will be used. In particular, the drones are for example multirotor drones intended for vertical flights in the manner of a helicopter, fixed-wing drones allowing high-speed flights over greater distances in the manner of an airplane, or hybrid drones allowing both types of flight.

These hybrid drones can form part of the category of vertical take-off and landing drones, included among vertical take-off and landing (VTOL) aircraft. Generally, these VTOL drones are formed of the combination of a conventional multirotor to which fixed wings and propulsion means are added, said propulsion means may be independent or provided by the rotors.

These hybrid drones have several disadvantages.

The main problem which the invention is aiming to solve is the low resistance to wind that the VTOL drones of the prior art have, which is largely due to the methods of movement in the vertical flight phase where, as for a helicopter, the lateral movements on the one hand and the forwards or backwards movements respectively require a roll or pitch motion of the aircraft so as to incline the lift of the drone in the desired direction. In windy conditions, in particular with a wind greater than 8 m/s, the geometry of the drone and in particular the presence of fixed wings cause on the one hand the increase in the area catching the wind owing to a large exposed surface facing towards or away from the wind, and cause on the other hand the generation of aerodynamic instability and drag and in particular the possibility of turbulent flow.

The VTOL drones of the prior art have other problems. On the one hand, the speed of the drone is particularly slow during vertical flight and rapid in airplane-type flight, without the possibility of maneuvering at intermediate speeds owing to a marked transition between the two flight modes. This problem limits the possibilities of taking off or landing in the presence of wind at different speeds. Furthermore, the VTOL drones generally have a large number of components (often at least four rotors) to make possible the hybrid design, which greatly reduces performance and increases the energy consumption and weight of the drone.

The inventors have thus sought to improve the existing drones, with a main criterion being increased resistance to wind.

### AIMS OF THE INVENTION

The invention aims to provide a hybrid drone having high resistance to windy conditions.

The invention aims to provide, in at least one embodiment, a hybrid drone allowing passive control of the attitude and inclination in order to reduce the surface area exposed to the wind.

The invention aims to provide, in at least one embodiment, a hybrid drone which can make precise movements at different speeds in different wind conditions.

The invention aims to provide, in at least one embodiment, a drone which can take off and land vertically, even in the presence of wind.

### DESCRIPTION OF THE INVENTION

To this end, the invention relates to a hybrid vertical take-off and landing drone comprising at least two substantially parallel fixed wings each comprising at least two fins distributed on either side of a roll axis of the drone and individually controlled, characterized in that it comprises at least two counter-rotating rotors with a collective pitch system and a swashplate, which are arranged between two wings on either side of the roll axis, individually controlled and articulated so as to allow independent tilting of each rotor on a tilt axis substantially parallel to the pitch axis of the drone, the rotational axis of the blades of each rotor being substantially perpendicular to said tilt axis.

A hybrid drone in accordance with the invention thus allows controlled movement in difficult windy meteorological conditions owing to the possibility of moving in every direction without exposing a surface to the wind and whilst remaining substantially horizontal during translation movements in the flight modes requiring the drone to remain horizontal, in particular at low and medium speed.

Throughout the application, the drone is defined in accordance with a conventional frame of reference for an aircraft, by the roll, pitch and yaw axes, and the movements on these axes are respectively called:
longitudinal movement for forwards or backwards movement on the roll axis,
lateral movement for movement to the left or to the right on the pitch axis, and
vertical movement for upwards or downwards movement on the yaw axis.

A rotor, also called rotary wing, is composed in a known manner of a set of blades, the high-speed rotation of which allows a lift to be formed. In the drone in accordance with the invention, each rotor has features close to a conventional helicopter rotor, in particular the presence of a collective pitch system making it possible to modify the lift of each rotor by inclining all the blades at the same inclination angle, and the presence of a swashplate making it possible to modify the lift of each rotor by variably inclining each blade depending upon its position around the rotor.

The two fixed wings are arranged in tandem around at least two counter-rotating rotors, i.e. rotors having opposite directions of rotation. The fixed wings thus further allow the rotors to be protected.

It is in particular the presence of the swashplate on each rotor, associated with independent control of each swashplate and with the presence of at least two counter-rotating rotors, which makes it possible to effect controlled movements. When the wind force is strong, i.e. when the air speed of the drone is high, the presence of the fixed wings makes it possible to add lift and pitch- and roll-control owing to the presence of the controllable fins. This control of the stability of the drone makes it possible on the one hand to use the drone in areas exposed to the wind, for example out at sea on offshore wind turbines or oil rigs, at ground speeds which can be zero. In particular, the drone can perform vertical take-off and landing on fixed or moving surfaces (for example on a land, air or nautical vehicle) and in the absence or presence of wind.

The hybrid drone in accordance with the invention thus differs from the drones of the prior art which require modification of their attitude or inclination to effect longitudinal or lateral movements and which therefore have a surface exposed to the wind, which does not allow controlled movements in areas exposed to the wind or vertical take-off and landing on moving surfaces.

The hybrid drone can comprise two or more rotors, preferably an even number of rotors symmetrically distributed about the roll axis for better balancing.

The drone is compatible with any type of use depending upon its dimensions and the power of the rotors, in particular:
transporting loads or people,
payload-dropping during flight,
taking images or inspection,
use in repair or maintenance,
etc.

Advantageously and in accordance with the invention, the drone comprises a system for controlling each fin and each rotor independently, comprising:
a module for the active control of movements, configured to control each fin and/or each rotor based on a flight control,
a module for the passive correction of attitude and inclination, configured to, in at least one flight mode of the drone, control each fin and/or each rotor so as to maintain a substantially zero inclination and an attitude of the drone.

According to this aspect of the invention, the passive control of attitude and inclination is intended to keep the drone permanently in the horizontal position (substantially zero inclination and attitude) whatever the received active movement controls. The passive, or slave, control thereby forms a closed-loop control of the attitude and inclination of the drone. The active, open-loop, controls are superposed onto the passive control.

This passive control makes it possible to permanently limit the exposure of the surfaces of the drone to the wind, which generally has a horizontal main component in the absence of relief. Therefore, the impact of the presence of wind is greatly reduced for the movements of the drone, which can thus move in translation whilst remaining flat, i.e. substantially horizontal.

The passive control also allows stable load transport, in particular for the stabilized transport of people with improved comfort.

A module can e.g. consist of a computing device such as a computer, a group of computing devices, an electronic component or a group of electronic components, or e.g. a computer program, a group of computer programs, a library of a computer program or a computer program function executed by a computing device such as a computer, a group of computing devices, an electronic component or a group of electronic components.

Advantageously and in accordance with the invention, the passive correction module is configured to control each fin and/or each rotor such that the roll axis of the drone is substantially parallel to the direction of the wind.

According to this aspect of the invention, the drone is automatically placed facing the wind so as to reduce disturbance caused by the wind and in order to facilitate the movements of the drone in the presence of wind.

Advantageously and in accordance with the invention, the passive correction module is configured for, in at least one flight mode of the drone:
controlling the pitch of the drone by controlling the swashplate of each rotor such that, for each rotor, the lift behind the rotor and the lift in front of the rotor are different,
controlling the roll of the drone by controlling the collective pitch system of each rotor such that each rotor has an average lift different from another rotor arranged on the other side of the roll axis,
controlling the yaw of the drone by controlling the tilt of each rotor on either side of the roll axis in opposite directions.

According to this aspect of the invention, the passive control is effected by controlling the swashplate, the collective pitch system and/or the tilting of each rotor. These passive control mechanisms can be used cumulatively in order to respond to different needs simultaneously, during a simultaneous correction of pitch and roll to keep the drone substantially horizontal for example. These controls are preferably specific to a flight mode referred to as vertical and a flight mode referred to as intermediate, when the air speed is between zero and a second predetermined threshold.

Advantageously and in accordance with the invention, the passive correction module is configured for, when the air speed of the drone is between a first predetermined threshold and a second predetermined threshold, the following additional controls:
additionally controlling the pitch of the drone by controlling each fin such that the lift of the fins in front of the pitch axis of the drone is different from the lift of the fins behind the pitch axis of the drone,
additionally controlling the roll of the drone by controlling each fin such that the lift of the fins on one side of the roll axis is different from the lift of the fins on the other side of the roll axis.

According to this aspect of the invention, these controls are specific to a flight mode referred to as intermediate, in the presence of wind or more generally when the air speed is between a first predetermined threshold and a second predetermined threshold, during which the fixed wings and the fins have an impact on the control of the drone.

In particular, the fins are controlled to modify the lift of each fixed wing so as to offer controls in addition to the controls of the rotors.

Advantageously and in accordance with the invention, the active control module is configured for, in at least one flight mode of the drone:
controlling the longitudinal translation of the drone by controlling the simultaneous tilting of all of the rotors in the same direction,
controlling the lateral translation of the drone by controlling the swashplate of each rotor such that, for each rotor, the lift to the left of the rotor and the lift to the right of the rotor are different,
controlling the vertical translation of the drone by controlling the collective pitch system of each rotor such that all of the rotors have the same lift.

According to this aspect of the invention, the active control is effected by controlling the swashplate, the collective pitch system and/or the tilting of each rotor. These passive control mechanisms can be used cumulatively in order to respond to several controls simultaneously, during a translation comprising longitudinal, lateral and vertical components.

These controls are preferably specific to a flight mode referred to as vertical and a flight mode referred to as intermediate, when the air speed is between zero and a second predetermined threshold.

Advantageously and in accordance with the invention, the active control module is configured for, when the air speed of the drone is between a first predetermined threshold and a second predetermined threshold, additionally controlling the vertical translation of the drone by additionally controlling each fin such that the lift of the fins in front of the pitch axis of the drone is different from the lift of the fins behind the pitch axis of the drone.

According to this aspect of the invention, this control is specific to a flight mode referred to as intermediate, in the presence of wind or more generally when the air speed is between a first predetermined threshold and a second predetermined threshold, during which the fixed wings and the fins have an impact on the control of the drone.

In particular, the fins are controlled to modify the lift of each fixed wing so as to allow vertical translation of the drone.

Advantageously and in accordance with the invention, the passive correction module comprises an inertial unit configured to provide information representing the attitude and inclination of the drone, the passive correction module being configured for closed-loop control based on said information representing the attitude and inclination of the drone.

According to this aspect of the invention, the inertial unit makes it possible to provide in real time the information necessary for forming the closed loop necessary to keep the drone in a substantially horizontal position, in particular in the presence of wind so as to avoid presenting a surface towards the wind.

Advantageously and in accordance with the invention, the drone is configured to be controlled in different flight modes from at least the following list of flight modes:
a vertical flight mode in which the air speed of the drone is less than a first predetermined threshold,
an intermediate flight mode in which the air speed of the drone is between the first predetermined threshold and a second predetermined threshold, and/or
a forward flight mode in which the air speed of the drone is greater than the second predetermined threshold.

According to this aspect of the invention, these different flight modes represent the hybrid aspect of the drone, the vertical flight mode being similar to the flight of a rotary wing aircraft such as a multirotor drone, the forward flight mode being similar to the flight of a fixed wing aircraft such as an airplane, and the intermediate flight mode allowing fluid transition between these two flight modes. The drone can be maneuvered and be stabilized at any air speed between zero speed and maximum speed.

Advantageously and in accordance with the invention, in the forward flight mode, the active control module is configured for:
controlling the tilting of each rotor such that the rotational axis of the blades of the rotor is substantially parallel to the roll axis,
controlling the pitch of the drone by controlling each fin such that the lift of the fins in front of the pitch axis of the drone is different from the lift of the fins behind the pitch axis of the drone,
controlling the roll of the drone by controlling each fin such that the lift of the fins on one side of the roll axis is different from the lift of the fins on the other side of the roll axis,
controlling the yaw of the drone by controlling the collective pitch system of each rotor such that each rotor has an average lift different from another rotor arranged on the other side of the roll axis.

According to this aspect of the invention, controlling the drone is similar to a flight of a fixed wing aircraft such as a propeller plane, the rotors acting as a propulsion means. The fins make it possible to control the roll and the pitch of the drone as a result of the air speed.

The invention also relates to a method for controlling a hybrid drone in accordance with the invention, characterized in that the control method comprises:
at least one step of controlling the swashplate of each rotor,
at least one step of controlling the collective pitch system of each rotor,
at least one step of controlling the tilting of each rotor on its tilt axis,
at least one step of controlling the deflection of each fin.

The invention also relates to a drone and a control method which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic perspective view of a hybrid drone in accordance with one embodiment of the invention.

FIG. 2 is a schematic top view of a hybrid drone in accordance with one embodiment of the invention.

FIG. 3 is a schematic perspective view of a hybrid drone in accordance with one embodiment of the invention, with pitch-control during a vertical flight mode.

FIG. 4 is a schematic perspective view of a hybrid drone in accordance with one embodiment of the invention, with roll-control during a vertical flight mode.

FIG. 5 is a schematic perspective view of a hybrid drone in accordance with one embodiment of the invention, with yaw-control during a vertical flight mode.

FIG. 6 is a schematic perspective view of a hybrid drone in accordance with one embodiment of the invention, with longitudinal translation-control during a vertical flight mode.

FIG. 7 is a schematic perspective view of a hybrid drone in accordance with one embodiment of the invention, with lateral translation-control during a vertical flight mode.

FIG. 8 is a schematic perspective view of a hybrid drone in accordance with one embodiment of the invention, with vertical translation-control during a vertical flight mode.

FIG. 9 is a schematic perspective view of a hybrid drone in accordance with one embodiment of the invention, with pitch-control during an intermediate flight mode.

FIG. 10 is a schematic perspective view of a hybrid drone in accordance with one embodiment of the invention, with roll-control during an intermediate flight mode.

FIG. 11 is a schematic perspective view of a hybrid drone in accordance with one embodiment of the invention, with yaw-control during an intermediate flight mode.

FIG. 12 is a schematic perspective view of a hybrid drone in accordance with one embodiment of the invention, with longitudinal translation-control during an intermediate flight mode.

FIG. 13 is a schematic perspective view of a hybrid drone in accordance with one embodiment of the invention, with lateral translation-control during an intermediate flight mode.

FIG. 14 is a schematic perspective view of a hybrid drone in accordance with one embodiment of the invention, with vertical translation-control during an intermediate flight mode.

FIG. 15 is a schematic perspective view of a hybrid drone in accordance with one embodiment of the invention, with pitch-control during a forward flight mode.

FIG. 16 is a schematic perspective view of a hybrid drone in accordance with one embodiment of the invention, with roll-control during a forward flight mode.

FIG. 17 is a schematic perspective view of a hybrid drone in accordance with one embodiment of the invention, with yaw-control during a forward flight mode.

### DETAILED DESCRIPTION OF AN EMBODIMENT OF THE INVENTION

In the figures, for the purposes of illustration and clarity, scales and proportions have not been strictly respected.

Furthermore, identical, similar or analogous elements are designated by the same reference signs in all the figures.

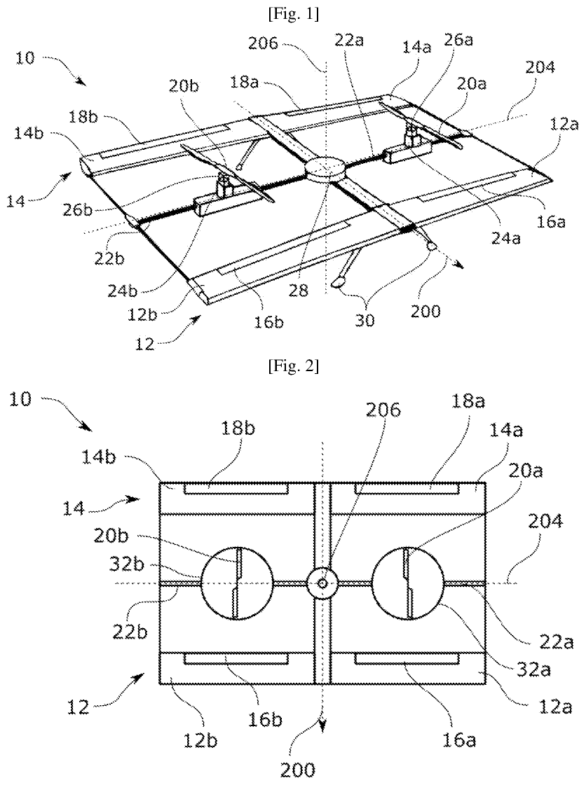

FIG. 1 and FIG. 2 show schematic perspective and top views of a hybrid vertical take-off and landing drone 10 in accordance with one embodiment of the invention.

The drone is defined in accordance with a conventional frame of reference for an aircraft, by a roll axis 200, a pitch axis 202 and a yaw axis 204, and the movements on these axes 200, 202, 204 are respectively called:
longitudinal movement for forwards (as shown by the arrow) or backwards movement on the roll axis 200,
lateral movement for movement to the left or to the right on the pitch axis 202, and
vertical movement for upwards or downwards movement on the yaw axis 204.

The plane formed by the roll axis 200 and the yaw axis 204 delimits the left and right of the drone. The plane formed by the roll axis 200 and the pitch axis 202 delimits the top and bottom of the drone. The plane formed by the pitch axis 202 and the yaw axis 204 delimits the front and back of the drone.

The hybrid drone 10 comprises at least two substantially parallel fixed wings, in this case a first wing 12 arranged at the front of the drone divided into a first part 12a on the left of the drone and a second part 12b on the right of the drone, and a second wing 14 arranged at the rear of the drone divided into a first part 14a on the left of the drone and a second part 14b on the right of the drone. In another embodiment, not shown, each wing cannot be divided and is formed of a single piece.

Each wing comprises at least two fins, one for each part of the wing, distributed on either side of the roll axis 200 of the drone and individually controlled: the first wing 12 comprises a first fin 16a on its first part 12a and a second fin 16b on its second part 12b, and the second wing 14 comprises a first fin 18a on its first part 14a and a second fin 18b on its second part 14b.

The hybrid drone also comprises at least two counter-rotating rotors, in this case a first rotor 20a and a second rotor 20b having opposite directions of rotation, arranged between the two wings 12, 14 on either side of the roll axis 200. The two rotors 20a, 20b are individually controlled and articulated respectively on a first tilt shaft 22a and a second tilt shaft 22b so as to allow independent tilting of each rotor 20a, 20b on a tilt axis substantially parallel to the pitch axis 202 of the drone, in this case coincident with the pitch axis 202. The rotational axis of the blades of each rotor 20a, 20b is substantially perpendicular to the tilt axis.

Each rotor is controlled according to a collective pitch system and a swashplate. The first rotor 20a comprises a first collective pitch system 24a making it possible to modify the angle of incidence of all of the blades of the aircraft over the entire rotation of each blade, and a first swashplate 26a making it possible to modify the angle of incidence of each blade depending upon its position during its rotation. The second rotor 20b comprises a second collective pitch system 24b and a second plate 26b for the same functions on the blades of the second rotor 20b.

The collective pitch system and the swashplate of each rotor 20a, 20b operate in a similar manner to those used in a helicopter.

Controlling of the rotors 20a, 20b, the shafts 22a, 22b, the collective pitch systems 24a, 24b, the swashplates 26a, 26b and the fins 16a, 16b, 18a, 18b is effected by a control system 28, for example arranged in the center of the drone 10 for improved stability of the drone. The control system 28 comprises a closed-loop passive control module controlling in particular the roll and the pitch of the drone so as to permanently maintain a horizontal position in at least one flight mode of the drone. The control system 28 also comprises an open-loop active control module making it possible to provide longitudinal, vertical or lateral translation movement controls of the drone.

The drone can comprise feet 30 or landing pads to permit the stability of the drone when it is placed on a surface.

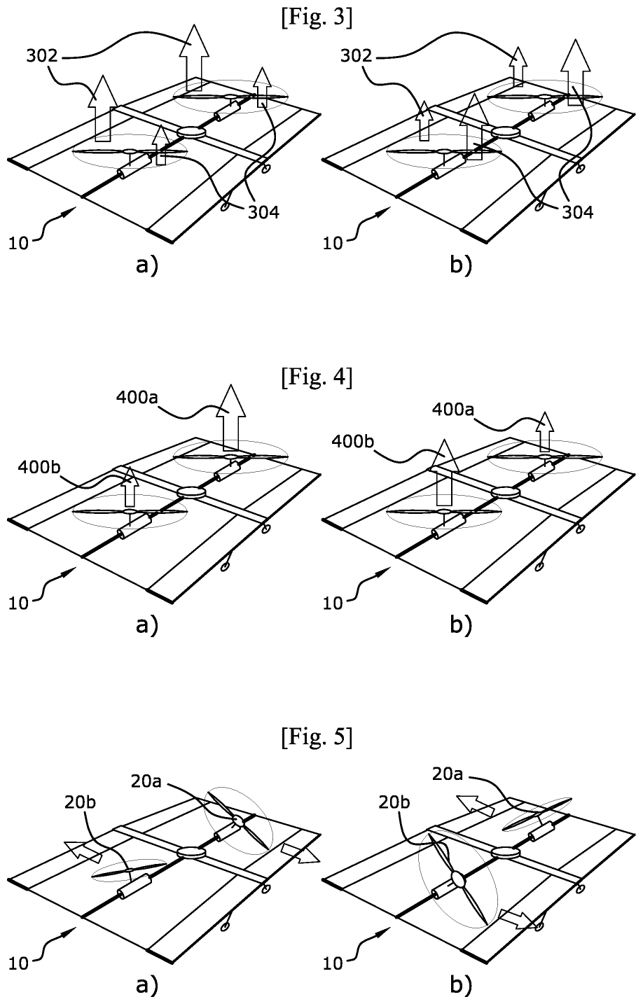

As shown in FIG. 2 and in FIGS. 3 to 17 described hereinafter, the rotation of the blades can be represented by a rotational disc, respectively a first rotational disc 32a for the first rotor 20a and a second rotational disc 32b for the second rotor 20b. In FIGS. 3 to 17, the lift of each portion of the rotor controlled by its collective pitch system and its swashplate are represented by arrows of different sizes based on the relative intensity of the lift, shown on the rotational disc of each rotor. This intensity of the lift is shown solely for illustrative purposes to show the lift in a simplified manner but is not associated with a particular lift value scale.

FIG. 3, FIG. 4 and FIG. 5 are schematic perspective views of a hybrid drone 10 in accordance with one embodiment, with respective pitch-, roll- and yaw-control during a flight mode referred to as vertical, i.e. when the air speed of the drone is less than a first predetermined threshold.

The pitch-control shown in FIG. 3 consists of controlling the swashplate of each rotor such that, for each rotor, the lift 302 behind the rotor and the lift 304 in front of the rotor are different.

For a reduction in attitude (nose-down) shown in part a), the rear lift 302 of each rotor is greater than the front lift 304 of each rotor. For an increase in attitude shown in diagram b), the rear lift 302 of each rotor is less than the front lift 304 of each rotor.

The roll-control shown in FIG. 4 consists of controlling the collective pitch system of each rotor such that each rotor has an average lift different from another rotor arranged on the other side of the roll axis.

For an inclination to the right shown in part a), the average lift 400a of the first rotor is greater than the average lift 400b of the second rotor. For an inclination to the left shown in part b), the average lift 400a of the first rotor is less than the average lift 400b of the second rotor.

The yaw-control shown in FIG. 5 consists of controlling the tilt of each rotor on either side of the roll axis in opposite directions.

For a rotation to the right shown in part a), the first rotor 20a is tilted to the front and the second rotor 20b is tilted to the rear. For a rotation to the left shown in part b), the first rotor 20a is tilted to the rear and the second rotor 20b is tilted to the front.

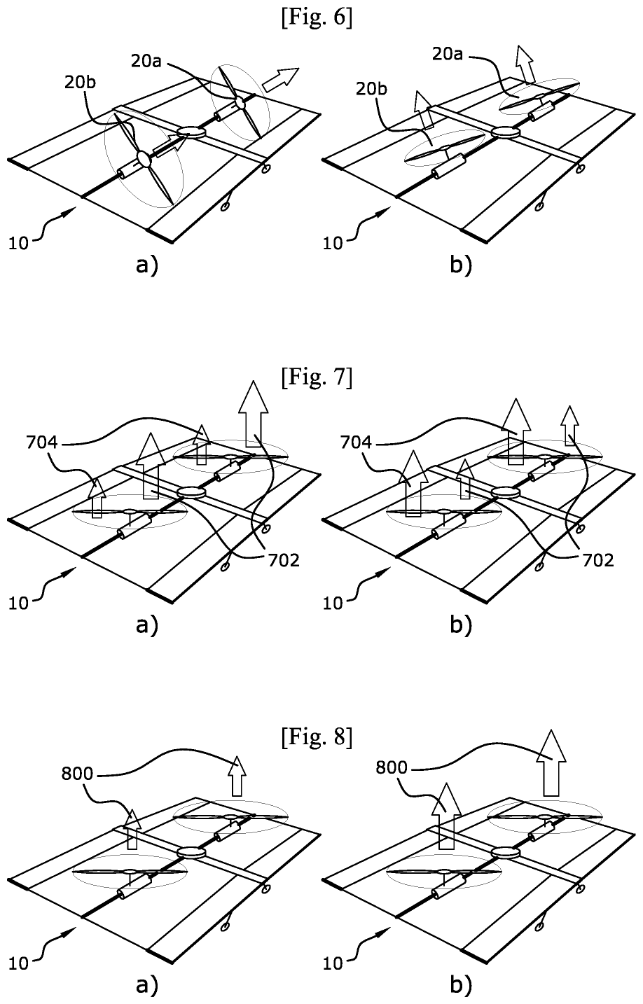

FIG. 6, FIG. 7 and FIG. 8 show schematic perspective views of a hybrid drone 10 in accordance with one embodiment, with respective longitudinal translation-, lateral translation- and vertical translation-control during the vertical flight mode.

The longitudinal translation-control shown in FIG. 6 consists of controlling the simultaneous tilting of all of the rotors in the same direction,

For a translation to the front shown in part a), the two rotors 20a, 20b are tilted to the front. For a translation to the rear shown in part b), the two rotors 20a, 20b are tilted to the rear.

The lateral translation-control shown in FIG. 7 consists of controlling the swashplate of each rotor such that, for each rotor, the lift 702 to the left of the rotor and the lift 704 to the right of the rotor are different.

For a translation to the right shown in part a), the lifts 702 to the left of the two rotors are greater than the lifts 704 to the right of the two rotors. For a translation to the left shown in part b), the lifts 702 to the left of the two rotors are less than the lifts 704 to the right of the two rotors.

The vertical translation-control shown in FIG. 8 consists of controlling the collective pitch system of each rotor such that all of the rotors have the same lift 800.

For a downwards translation shown in part a), the lifts generated by the two rotors are identical and less than the weight of the drone, which descends. For an upwards translation shown in part b), the lifts generated by the two rotors are identical and greater than the weight of the drone, which rises.

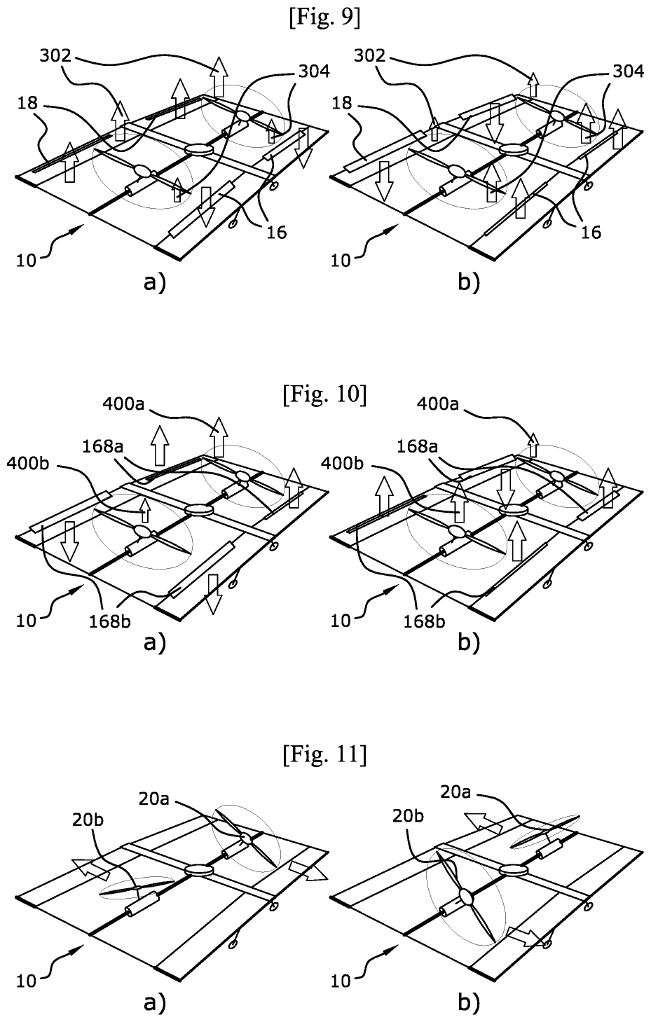

FIG. 9, FIG. 10 and FIG. 11 are schematic perspective views of a hybrid drone 10 in accordance with one embodiment, with respective pitch-, roll- and yaw-control during a flight mode referred to as intermediate, i.e. when the air speed of the drone is between the first predetermined threshold and a second predetermined threshold. This flight mode permits in particular maneuvering in the presence of strong wind.

The pitch-control shown in FIG. 9 consists of controlling the swashplate of each rotor such that, for each rotor, the lift 302 behind the rotor and the lift 304 in front of the rotor are different, and controlling each fin such that the lift of the fins 16 in front of the pitch axis of the drone is different from the lift of the fins 18 behind the pitch axis of the drone.

For a reduction in attitude (nose-down) shown in part a), the rear lift 302 of each rotor is greater than the front lift 304 of each rotor, the fins 16 of the front wing are inclined upwards in order to reduce the lift and the fins 18 of the rear wing are inclined downwards to increase the lift. For an increase in attitude shown in diagram b), the rear lift 302 of each rotor is less than the front lift 304 of each rotor, the fins 16 of the front wing are inclined downwards in order to increase the lift and the fins 18 of the rear wing are inclined upwards to reduce the lift.

The roll-control shown in FIG. 10 consists of controlling the collective pitch system of each rotor such that each rotor has an average lift different from another rotor arranged on the other side of the roll axis, and controlling each fin such that the lift of the fins on one side of the roll axis is different from the lift of the fins on the other side of the roll axis.

For an inclination to the right shown in part a), the average lift 400a of the first rotor is greater than the average lift 400b of the second rotor, the fins 168b located on the right of the drone are inclined upwards in order to reduce the lift and the fins 168a on the left of the drone are inclined downwards to increase the lift. For an inclination to the left shown in part b), the average lift 400a of the first rotor is less than the average lift 400b of the second rotor, the fins 168b located on the right of the drone are inclined downwards in order to increase the lift and the fins 168a on the left of the drone are inclined upwards to reduce the lift.

The yaw-control shown in FIG. 11 consists of controlling the tilt of each rotor on either side of the roll axis in opposite directions.

For a rotation to the right shown in part a), the first rotor 20a is tilted to the front and the second rotor 20b is tilted to the rear. For a rotation to the left shown in part b), the first rotor 20a is tilted to the rear and the second rotor 20b is tilted to the front.

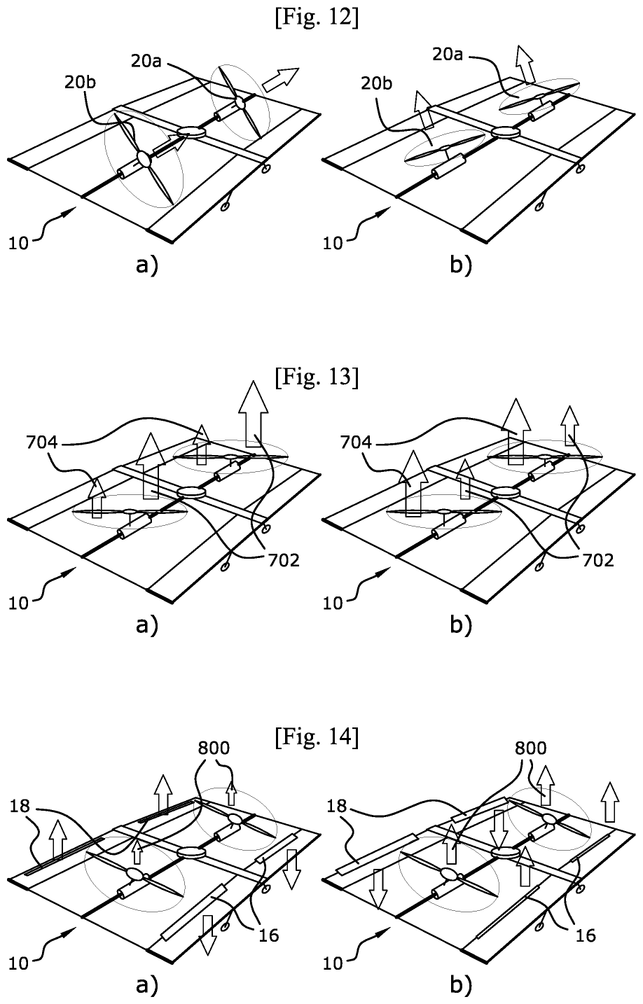

FIG. 12, FIG. 13 and FIG. 14 show schematic perspective views of a hybrid drone 10 in accordance with one embodiment, with respective longitudinal translation-, lateral translation- and vertical translation-control during the intermediate flight mode.

The longitudinal translation-control shown in FIG. 12 consists of controlling the simultaneous tilting of all of the rotors in the same direction,

For a translation to the front shown in part a), the two rotors 20a, 20b are tilted to the front. This translation to the front can, in the presence of wind, allow positive air speed movement but zero ground speed. For a translation to the rear shown in part b), the two rotors 20a, 20b are tilted to the rear.

The lateral translation-control shown in FIG. 13 consists of controlling the swashplate of each rotor such that, for each rotor, the lift to the left of the rotor and the lift to the right of the rotor are different.

For a translation to the right shown in part a), the lifts 702 to the left of the two rotors are greater than the lifts 704 to the right of the two rotors. For a translation to the left shown in part b), the lifts 702 to the left of the two rotors are less than the lifts 704 to the right of the two rotors.

The vertical translation-control shown in FIG. 14 consists of controlling the collective pitch system of each rotor such that all the rotors have the same lift, and controlling each fin such that the lift of the fins in front of the pitch axis of the drone is different from the lift of the fins behind the pitch axis of the drone.

For a downwards translation shown in part a), the lifts 800 generated by the two rotors are identical and less than the weight of the drone, the fins 16 of the front wing are inclined upwards in order to reduce the lift and the fins 18 of the rear wing are inclined downwards to increase the lift, and the drone descends. For an upwards translation shown in part b), the lifts 800 generated by the two rotors are identical and greater than the weight of the drone, the fins 16 of the front wing are inclined downwards in order to increase the lift and the fins 18 of the rear wing are inclined upwards to reduce the lift, and the drone rises.

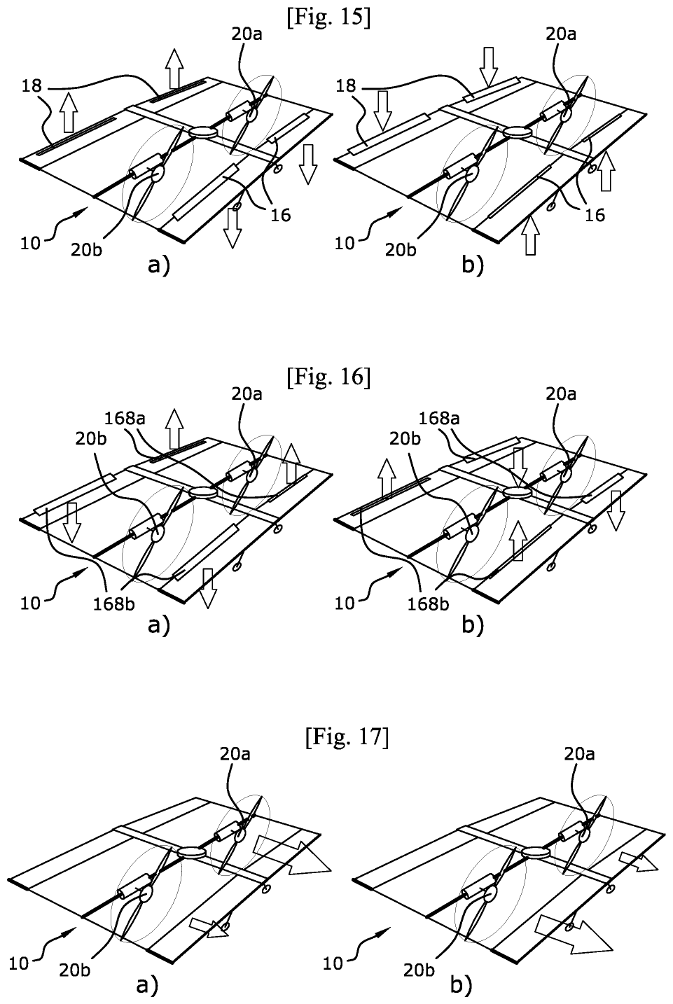

FIG. 15, FIG. 16 and FIG. 17 are schematic perspective views of a hybrid drone 10 in accordance with one embodiment, with respective pitch-, roll- and yaw-control during a flight mode referred to as forward, i.e. when the air speed of the drone is greater than the second predetermined threshold. This flight mode is similar to a flight of a fixed wing aircraft such as an airplane. In this flight mode, the drone is configured for controlling the tilting of each rotor such that the rotational axis of the blades of the rotor is substantially parallel to the roll axis, the rotors 20a, 20b thereby forming the propulsion means of the drone.

The pitch-control shown in FIG. 15 consists of controlling each fin such that the lift of the fins 16 in front of the pitch axis of the drone is different from the lift of the fins 18 behind the pitch axis of the drone.

For a reduction in attitude (nose-down) shown in part a), the fins 16 of the front wing are inclined upwards in order to reduce the lift and the fins 18 of the rear wing are inclined downwards to increase the lift. For an increase in attitude shown in diagram b), the fins 16 of the front wing are inclined downwards in order to increase the lift and the fins 18 of the rear wing are inclined upwards to reduce the lift.

The roll-control shown in FIG. 16 consists of controlling each fin such that the lift of the fins on one side of the roll axis is different from the lift of the fins on the other side of the roll axis.

For an inclination to the right shown in part a), the fins 168b located on the right of the drone are inclined upwards in order to reduce the lift and the fins 168a on the left of the drone are inclined downwards to increase the lift. For an inclination to the left shown in part b), the fins 168b located on the right of the drone are inclined downwards in order to increase the lift and the fins 168a on the left of the drone are inclined upwards to reduce the lift.

The yaw-control shown in FIG. 17 consists of controlling the collective pitch system of each rotor such that each rotor has an average lift different from another rotor arranged on the other side of the roll axis.

For a rotation to the right shown in part a), the average lift of the first rotor 20a is greater than the average lift of the second rotor 20b. For a rotation to the left shown in part b), the average lift of the first rotor 20a is less than the average lift of the second rotor 20b.

The invention is not limited to the embodiment described. In particular, the shape of the fixed wings and the rotors and the arrangement thereof may be different.

1. A hybrid vertical take-off and landing drone comprising at least two substantially parallel fixed wings each comprising at least two fins distributed on either side of a roll axis of the drone and individually controlled, characterized in that it comprises at least two counter-rotating rotors with a collective pitch system and a swashplate, which are arranged between two wings on either side of the roll axis, individually controlled and articulated so as to allow independent tilting of each rotor on a tilt axis substantially parallel to the pitch axis of the drone, the rotational axis of the blades of each rotor being substantially perpendicular to said tilt axis.

2. The hybrid drone as claimed in claim 1, further comprising a system for controlling each fin and each rotor independently, comprising:
a module for the active control of movements, configured to control each fin and/or each rotor based on a flight control,
a module for the passive correction of attitude and inclination, configured to, in at least one flight mode of the drone, control each fin and/or each rotor so as to maintain a substantially zero inclination and an attitude of the drone.

3. The hybrid drone as claimed in claim 2, wherein the passive correction module is configured to control each fin and/or each rotor such that the roll axis of the drone is substantially parallel to the direction of the wind.

4. The hybrid drone as claimed in claim 2, wherein the passive correction module is configured for, in at least one flight mode of the drone:
controlling the pitch of the drone by controlling the swashplate of each rotor such that, for each rotor, the lift behind the rotor and the lift in front of the rotor are different,
controlling the roll of the drone by controlling the collective pitch system of each rotor such that each rotor has an average lift different from another rotor arranged on the other side of the roll axis,
controlling the yaw of the drone by controlling the tilt of each rotor on either side of the roll axis in opposite directions.

5. The hybrid drone as claimed in claim 4, wherein the passive correction module is configured for, when the air speed of the drone is between a first predetermined threshold and a second predetermined threshold, the following additional controls:
additionally controlling the pitch of the drone by controlling each fin such that the lift of the fins in front of the pitch axis of the drone is different from the lift of the fins behind the pitch axis of the drone,
additionally controlling the roll of the drone by controlling each fin such that the lift of the fins on one side of the roll axis is different from the lift of the fins on the other side of the roll axis.

6. The hybrid drone as claimed in claim 2, wherein the active control module is configured for, in at least one flight mode of the drone:
controlling the longitudinal translation of the drone by controlling the simultaneous tilting of all of the rotors in the same direction,
controlling the lateral translation of the drone by controlling the swashplate of each rotor such that, for each rotor, the lift on the left of the rotor and the lift on the right of the rotor are different,
controlling the vertical translation of the drone by controlling the collective pitch system of each rotor such that all of the rotors have the same lift.

7. The hybrid drone as claimed in claim 6, wherein the active control module is configured for, when the air speed of the drone is between a first predetermined threshold and a second predetermined threshold, additionally controlling the vertical translation of the drone by additionally controlling each fin such that the lift of the fins in front of the pitch axis of the drone is different from the lift of the fins behind the pitch axis of the drone.

8. The hybrid drone as claimed in claim 2, wherein the passive correction module comprises an inertial unit configured to provide information representing the attitude and inclination of the drone, the passive correction module being configured for closed-loop control based on said information representing the attitude and inclination of the drone.

9. The hybrid drone as claimed in claim 1, wherein the drone is configured to be controlled in different flight modes from at least the following list of flight modes:
a vertical flight mode in which the air speed of the drone is less than a first predetermined threshold,
an intermediate flight mode in which the air speed of the drone is between the first predetermined threshold and a second predetermined threshold, and/or
a forward flight mode in which the air speed of the drone is greater than the second predetermined threshold.

10. The hybrid drone as claimed in claim 9, wherein in the forward flight mode, the active control module is configured for:
controlling the tilting of each rotor such that the rotational axis of the blades of the rotor is substantially parallel to the roll axis,
controlling the pitch of the drone by controlling each fin such that the lift of the fins in front of the pitch axis of the drone is different from the lift of the fins behind the pitch axis of the drone,
controlling the roll of the drone by controlling each fin such that the lift of the fins on one side of the roll axis is different from the lift of the fins on the other side of the roll axis,
controlling the yaw of the drone by controlling the collective pitch system of each rotor such that each rotor has an average lift different from another rotor arranged on the other side of the roll axis.

11. A method for controlling a hybrid drone comprising at least two substantially parallel fixed wings each comprising at least two fins distributed on either side of a roll axis of the drone and individually controlled, characterized in that it comprises at least two counter-rotating rotors with a collective pitch system and a swashplate, which are arranged between two wings on either side of the roll axis, individually controlled and articulated so as to allow independent tilting of each rotor on a tilt axis substantially parallel to the pitch axis of the drone, the rotational axis of the blades of each rotor being substantially perpendicular to said tilt axis the method comprising: controlling the swashplate of each rotor, controlling the collective pitch system of each rotor, controlling the tilting of each rotor on its tilt axis, controlling the deflection of each fin.
